(19) United States
(12) Patent Application Publication
(10) Pub. No.: US 2007/0196035 A1
(43) Pub. Date: Aug. 23, 2007

(54) Dynamic pressure bearing unit

(76) Inventors: Katsuo Shibahara, Kuwana-shi (JP); Ryouichi Nakajima, Kuwana-shi (JP); Kenji Ito, Kuwana-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/567,686

(22) PCT Filed: Sep. 21, 2004
(86) PCT No.: PCT/JP04/14138

§ 371 Date: Aug. 29, 2006

(30) Foreign Application Priority Data
Sep. 22, 2003 (JP) 2003-329792

(51) Int. Cl. F16C 32/06

(52) U.S. Cl. 384/107

(57) ABSTRACT

The invention is aimed at further reducing the cost of a dynamic pressure bearing unit. In a shaft member 2, a shaft portion 2a is disposed with the outer circumferential surface thereof facing the inner circumferential surface of a bearing sleeve across a radial bearing gap, while a flange portion 2b is disposed with both end faces 2b1 and 2b2 thereof respectively facing one end face of the bearing sleeve and a bottom face of a housing across respective thrust bearing gaps, and the shaft member 2 is supported in a thrust direction in a noncontact fashion by a dynamic pressure occurring in each bearing gap. In the shaft member 2, the core of the shaft portion 2a and the flange portion 2b are both formed from a resin member 21, while the outer circumference of the shaft portion 2a is formed from a metal member 22.

### TECHNICAL FIELD

The present invention relates to a dynamic pressure bearing unit. The dynamic pressure bearing unit of the invention is advantageous for use as a bearing unit, for example, for a spindle motor used in an information apparatus such as a magnetic disk apparatus like an HDD or FDD, an optical disk apparatus like a CD-ROM, CD-R/RW, or DVD-ROM/RAM drive, or a magneto-optical disk apparatus like an MD or MO drive, or for a small motor such as a polygon scanner motor used in a laser beam printer (LBP) or a motor used for a projector's color wheel or an electrical appliance, for example, an axial fan.

### BACKGROUND ART

A dynamic pressure bearing is a bearing for supporting a shaft member in a noncontact fashion by a fluid dynamic pressure occurring in a bearing gap. Bearing units (dynamic pressure bearing units) using such dynamic pressure bearings are roughly classified into two types, the contact type in which the radial bearing portion is constructed with a dynamic pressure bearing and the thrust bearing portion with a pivot bearing, and the noncontact type in which the radial bearing portion and the thrust bearing portion are both constructed with dynamic pressure bearings, and one or the other type, whichever appropriate, is selected for use according to the purpose.

Of these types, one known example of the noncontact type is the dynamic pressure bearing unit proposed by the applicant in Japanese Unexamined Patent Publication No. 2000-291648. In this bearing unit, a shaft portion and a flange portion which together constitute a shaft member are integrally formed as a single unit from the standpoint of reducing the cost and achieving higher precision.

However, in recent years, the demand for cost reductions has been increasing more than ever, and to meet such demand, it is needed to further reduce the cost of each individual component of the dynamic pressure bearing unit.

### DISCLOSURE OF THE INVENTION

In view of the above situation, it is a primary object of the present invention to further reduce the cost of the noncontact type dynamic pressure bearing unit.

As a means for achieving the above object, the present invention provides a dynamic pressure bearing unit comprising: a bearing sleeve; a shaft member having a shaft portion inserted along an inner circumference of the bearing sleeve, and a flange portion extending radially outwardly of the shaft portion; a radial bearing portion for supporting the shaft member in a radial direction in a noncontact fashion by fluid dynamic pressure action occurring in a radial bearing gap; and a thrust bearing portion for supporting the shaft member in a thrust direction in a noncontact fashion by fluid dynamic pressure action occurring in a thrust bearing gap, wherein an outer circumference of the shaft portion of the shaft member is formed from a cylindrically shaped hollow metal member, while the flange portion and a core of the shaft portion are both formed from a resin member.

In this way, by forming the outer circumference of the shaft portion from a metal member, not only can the strength and rigidity required of the shaft member be ensured, but the wear resistance of the shaft portion against the metal bearing sleeve made of a sintered metal or the like can also be ensured. On the other hand, since many parts of the shaft member (such as the flange portion and the core of the shaft portion) are made of resin, the weight of the shaft member can be reduced, thus reducing the inertia of the shaft member; this serves to reduce the impact load when the shaft member collides with other bearing component parts (such as the bearing sleeve and the housing bottom), and thereby to prevent such portions from being scratched or nicked by the collision. Furthermore, since the flange portion is made of resin, its sliding friction is small, and the coefficient of friction between the flange portion and the other bearing component parts can be reduced.

Generally, in a noncontact type dynamic pressure bearing, the viscosity of the fluid (oil, etc.) decreases at high temperatures, and degradation of the bearing rigidity, in particular, in thrust directions, becomes a problem. In this case, when the flange portion is formed from a resin member, as described above, since the faces of other members (such as the end face of the bearing sleeve and the inside bottom face of the housing) that face the end faces of the flange portion are usually made of metal, the thrust bearing gaps decrease because of the axial thermal expansion of the resin flange portion whose coefficient of linear expansion (in particular, coefficient of linear expansion in the axial direction) is larger than that of the metal; this serves to suppress the decrease of the bearing rigidity in the thrust directions due to high temperatures. Conversely, at low temperatures, the viscosity of the fluid increases, increasing the motor torque, but when the flange portion is formed from a resin member, since the thrust bearing gaps increase because of the difference in axial thermal expansion, it becomes possible to suppress the increase of the motor torque due to low temperatures.

The shaft member can be formed by molding a resin in a mold cavity using the metal member as an insert. In this way, by employing the insert molding (including outsert molding: the same applies hereinafter), high precision shaft members can be mass produced at low cost just by increasing mold accuracy and by accurately positioning the metal member as the insert within the mold cavity. In particular, in the noncontact type dynamic pressure bearing unit, high dimensional accuracy, including the squareness between the shaft portion and the flange portion, is required of the shaft member, and the insert molding can satisfactorily address this kind of requirement.

It is preferable that, in the shaft member, a plurality of dynamic pressure grooves are formed at least in one end face of the flange portion. In this case, a groove pattern corresponding to the dynamic pressure groove pattern is formed on the mold, and a molten resin is filled into the mold and cured to transfer the groove pattern; in this way, dynamic pressure grooves of good accuracy can be formed at low cost. At this time, since the dynamic pressure grooves can be formed simultaneously with the molding of the flange portion, the number of fabrication steps can be reduced, achieving a further reduction in cost, than would be the case if the molding of the flange portion and the formation of the dynamic pressure grooves were performed in separate steps, for example, if the metal flange were formed by forging, and then the dynamic pressure grooves were formed by pressing on both end faces of the flange.

If a thread into which a separate member is to be screwed is formed in an opposite end portion of the shaft member from the flange portion, the separate member (for example, a cap or the like for fixedly holding a disk) can be accurately and securely fastened to the end opposite from the flange portion provided at the other end of the shaft member. In this case, if the thread is formed around an inner circumference of an end portion of the metal member, the separate member can be screwed into the metal member, increasing the fastening strength.

The dynamic pressure bearing unit described above is further provided with a housing in which the bearing sleeve is accommodated, and the flange portion can be disposed with one end face thereof facing an end face of the bearing sleeve and with the other end face thereof facing the bottom face of the housing. In this case, the gap between the one end face of the flange portion and the end face of the bearing sleeve and the gap between the other end face of the flange portion and the bottom face of the housing can be used, for example, as the thrust bearing gaps.

According to the present invention, because of the lightening of the shaft member can be achieved, the impact due to collisions between the shaft member and other members, for example, during transport, can be reduced, and scratches, etc. can be prevented from being caused due to the impact load. Furthermore, not only can the bearing rigidity in thrust directions be retained even at high temperatures, but also the increase of the motor torque due to low temperatures can be suppressed.

### BRIEF DESCRIPTION OF THE PRESENT INVENTION

FIG. 1 is a side view, partly in cross section, of a shaft member according to the present invention;

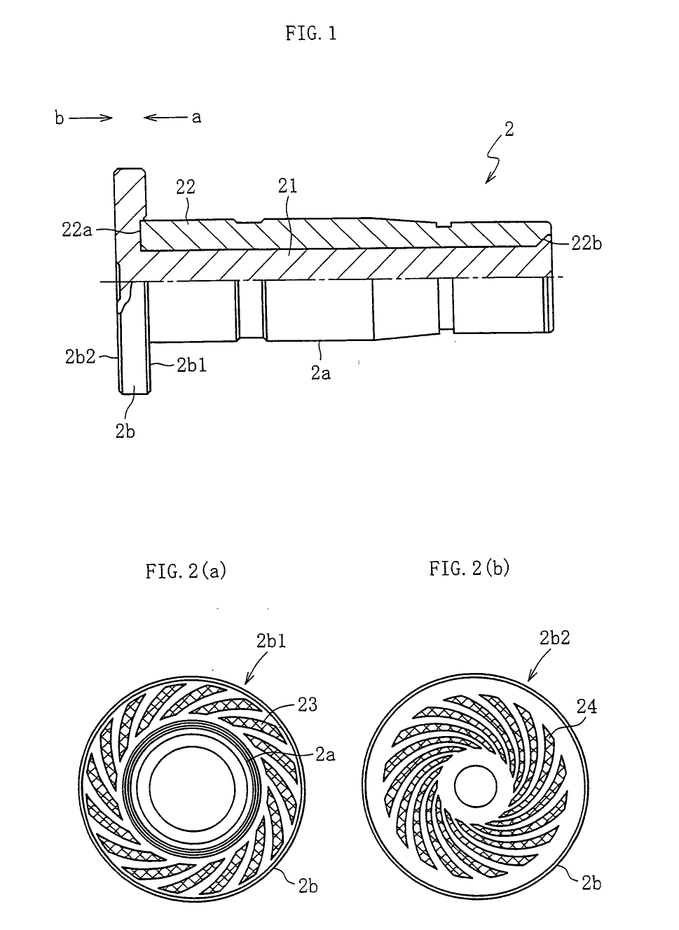

FIG. 2(a) is a top plan view of a flange portion (a view in the direction of arrow “a” in FIG. 1), and FIG. 2(b) is a bottom view of the flange portion (a view in the direction of arrow “b” in FIG. 1);

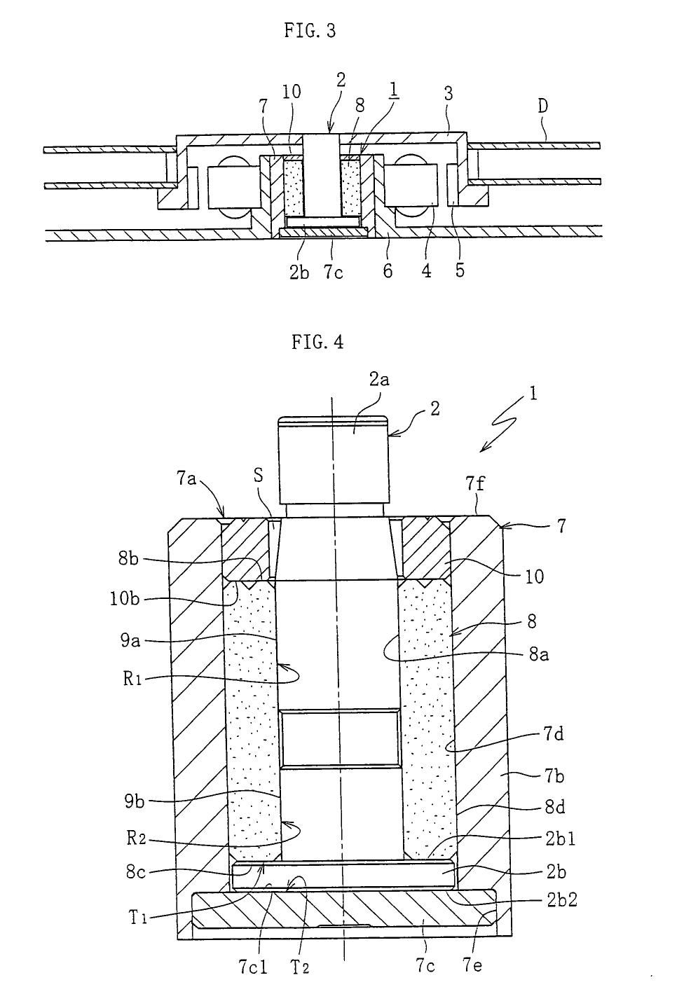

FIG. 3 is a cross sectional view of an HDD spindle motor incorporating a dynamic pressure bearing unit;

FIG. 4 is a cross sectional view of the dynamic pressure bearing unit;

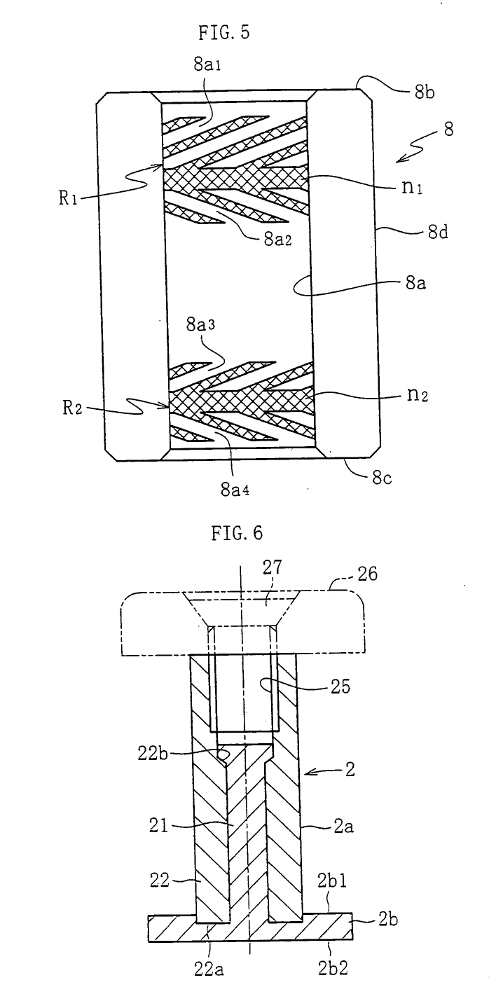

FIG. 5 is a cross sectional view of a bearing sleeve; and

FIG. 6 is a cross sectional view showing an alternative embodiment of the shaft member according to the present invention.

### BEST MODE FOR CARRYING OUT THE INVENTION

An embodiment of the present invention will be described below with reference to FIGS. 1 to 6.

FIG. 3 shows one example of the construction of a spindle motor, used in an information apparatus, that incorporates a dynamic pressure bearing unit 1 according to the embodiment of the present invention. The spindle motor is used in a disk drive apparatus such as an HDD, and comprises the dynamic pressure bearing unit 1 which rotatably supports a shaft member 2 in a noncontact fashion, a disk hub 3 attached to the shaft member 2, and a motor stator 4 and a motor rotor 5 disposed opposite each other across a radial gap. The stator 4 is mounted on the outer circumference of a casing 6, while the rotor 5 is attached to the inner circumference of the disk hub 3. The housing 7 of the dynamic pressure bearing unit 1 is fixed to the inner circumference of the casing 6 by gluing or press fitting thereto. The disk hub 3 holds thereon one or a plurality of disks D such as magnetic disks. When the stator 4 is energized, the rotor 5 rotates because of the magnetic force produced between the stator 4 and the rotor 5, and thus the disk hub 3 and the shaft member 2 rotate together.

FIG. 4 shows one embodiment of the dynamic pressure bearing unit 1. Major components of the dynamic pressure bearing unit 1 are: a cylindrically shaped closed-end housing 7 having an opening 7a at one end and a bottom 7c at the other end; a cylindrically shaped bearing sleeve 8 fixed to the inner circumference of the housing 7; a shaft member 2 comprising a shaft portion 2a and a flange portion 2b; and a sealing member 10 fixed to the opening 7a of the housing 7. For convenience of explanation, the following description is given by taking the opening 7a side of the housing 7 as the upper side and the bottom 7c side of the housing 7 as the lower side.

The housing 7 is formed, for example, from a soft metal material such as brass, and includes a cylindrically shaped side portion 7b which is formed separately from the disk shaped bottom portion 7c. The lower end of the inner circumferential surface 7d of the housing 7 is formed as a large diameter portion 7e which is larger in diameter than the other portion, and a lid-like member forming the bottom 7c is fixed into the large diameter portion 7e by such means as swaging, gluing, or press fitting. Here, the side portion 7b and the bottom portion 7c of the housing 7 may be formed integrally.

The bearing sleeve 8 is formed from a sintered metal, and more specifically, a porous sintered metal impregnated with oil. Upper and lower two dynamic pressure groove regions, one separated from the other in the axial direction, and each forming a radial bearing face for generating a dynamic pressure, are formed on the inner circumferential surface 8a of the bearing sleeve 8.

As shown in FIG. 5, the upper radial bearing face contains a plurality of dynamic pressure grooves 8a1, 8a2 formed in a herringbone pattern. In this radial bearing face, the axial length of each dynamic pressure groove 8a1 in the upper part of the figure is larger than that of each dynamic pressure groove 8a2 formed in the lower part thereof and slanting in the opposite direction; that is, the pattern is made asymmetrical in the axial direction. Likewise, the lower radial bearing face contains a plurality of dynamic pressure grooves 8a3, 8a4 formed in a herringbone pattern, the plurality of dynamic pressure grooves 8a3 slating upward in the axial direction being axially spaced apart from the plurality of dynamic pressure grooves 8a4 slating downward in the axial direction. In the present embodiment, however, unlike the dynamic pressure grooves 8a1 and 8a2 formed in the upper radial bearing face, the axial lengths of both the dynamic pressure grooves 8a3 and 8a4 are equal, so that the pattern is symmetrical in the axial direction. The axial length of the upper radial bearing face (the distance between the upper end of the dynamic pressure groove 8a1 and the lower end of the dynamic pressure groove 8a2) is larger than the axial length of the lower radial bearing face (the distance between the upper end of the dynamic pressure groove 8a3 and the lower end of the dynamic pressure groove 8a4).

Radial bearing gaps 9a and 9b are respectively formed between the upper and lower radial bearing faces on the inner circumferential surface of the bearing sleeve 8 and the corresponding faces on the outer circumferential surface of the shaft portion 2a that face the respective bearing faces. The upper ends of the radial bearing gaps 9a and 9b are open to the outside air via the sealing member 10, while the lower ends thereof are sealed against the outside air.

Generally, in dynamic pressure grooves formed in an axially slanting pattern such as a herringbone pattern, oil is drawn in the axial direction during operation of the bearing. Accordingly, in the present embodiment also, the dynamic pressure grooves 8a1 to 8a4 act as oil drawing grooves, and the oil drawn through the oil drawing grooves 8a1 to 8a4 into the radial bearing gaps 9a and 9b gathers around the smooth surface portions n1 and n1 between the dynamic pressure grooves 8a1 and 8a2 and between the dynamic pressure grooves 8a3 and 8a4, resulting in the formation or a continuous oil film along the circumferential direction.

At this time, the oil filled into the gap between the outer circumferential surface of the shaft portion 2a and the inner circumferential surface 8a of the bearing sleeve 8 is generally pushed downward because of the asymmetry of the upper radial bearing face and the difference between the axial lengths of the upper and lower radial bearing faces. In order that the oil pushed downward can be pushed back upward, the bearing sleeve 8 is provided in the outer circumferential surface 8d thereof with a circulating groove (not shown) opened in both end faces 8b and 8c of the bearing sleeve 8. The circulating groove may be formed in the inner circumferential surface 7d of the housing.

The dynamic pressure groove pattern in each dynamic pressure groove region can be a pattern in which the dynamic pressure grooves 8a1 to 8a4 are formed slanting in the axial direction. Besides the herringbone pattern shown, a spiral pattern may be considered as the dynamic pressure groove pattern that satisfies the above requirement.

As shown in FIG. 4, the sealing member 10 as the sealing means is annular in shape, and is secured to the inner circumferential surface of the opening 7a of the housing 7 by such means as press fitting or gluing. In the present embodiment, the inner circumference of the sealing member 10 forms a cylindrical shape, and the lower end face 10b of the sealing member 10 is in contact with the upper end face 8b of the bearing sleeve 8.

A tapered face is formed on the outer circumferential surface of the shaft portion 2a that faces the inner circumferential surface of the sealing member 10, and a tapered sealing space S gradually becoming larger toward the upper end of the housing 7 is formed between the tapered face and the inner circumferential surface of the sealing member 10. Lubricating oil is filled into the interior space of the housing 7 hermetically sealed by the sealing member 10, and the gaps formed inside the housing, that is, the gap (including the radial bearing gaps 9a and 9b) between the outer circumferential surface of the shaft portion 2a and the inner circumferential surface 8a of the bearing sleeve 8, the gap between the lower end face 8c of the bearing sleeve 8 and the upper end face 2b1 of the flange portion 2b, and the gap between the lower end face 2b2 of the flange portion and the inside bottom face 7c1 (housing bottom) of the housing 7, are filled with the lubricating oil. The oil level of the lubricating oil is located within the sealing space S.

The shaft portion 2a of the shaft member 2 is inserted along the inner circumferential surface 8a of the bearing sleeve 8, and the flange portion 2b is accommodated in a space formed between the lower end face 8c of the bearing sleeve 8 and the inside bottom face 7c1 of the housing 7. The upper and lower two radial bearing faces on the inner circumferential surface 8a of the bearing sleeve 8 face the outer circumferential surface of the shaft portion 2a across the respective radial bearing gaps 9a and 9b, thus forming the first radial bearing portion R1 and the second radial bearing portion R2, respectively.

As shown in FIG. 1, the shaft member 2 is a composite structure comprising a resin member 21 and a metal member 22, in which the core of the shaft portion 2a and the entire portion of the flange 2b are formed integrally from the resin member 21, and the shaft portion 2a is covered along the entire length of its outer circumference with the cylindrically shaped hollow metal member 22. For the resin member 21, use can be made of 66 Nylon, LCP, PES, etc., and a filler such as glass fiber is added as needed to such resins. For the metal member 22, use can be made, for example, of stainless steel having excellent wear resistance.

To prevent separation between the resin member 21 and the metal member 22, one end of the metal member 22 is embedded in the flange portion 2b at the lower end (at the left side of the figure) of the shaft portion 2a of the shaft member 2, while at the upper end thereof, the metal member 22 is axially held into engagement with the resin member 21 by means of an engaging portion. In the illustrated example, the two members are held into engagement with each other by means of a tapered face 22b having a diameter increasing toward the upper end. To lock the metal member 22 against rotation, it is desirable that an engaging portion with a roughened surface formed by knurling or the like, and capable of engaging with the flange portion 2b along the circumferential direction, be provided on the outer circumference or an edge portion of the metal member 22 embedded in the flange portion 2b.

The shaft member 2 is fabricated, for example, by injection-molding the resin with the metal member 22 used as an insert (insert molding). High dimensional accuracy, such as the squareness between the shaft portion 2a and the flange portion 2b and the parallelism between the flange end faces 2b1 and 2b2, is required of the shaft member 2 because of the function of the noncontact type bearing unit; when the insert molding is employed, mass production can be achieved at low cost while satisfying the accuracy requirements, by increasing mold accuracy and by accurately positioning the metal member 22 as the insert within the mold cavity. Furthermore, since the integral fabrication of the shaft portion 2a with the flange portion 2b is completed upon completion of the molding, the number of fabrication steps can be reduced, achieving a further reduction in cost, than would be the case if the shaft portion and the flange portion were produced as separate metal components and were assembled together by such means as press fitting in a subsequent step.

A dynamic pressure groove region as a thrust bearing face for generating a dynamic pressure is formed on each of the end faces 2b1 and 2b2 of the flange portion 2b. As shown in FIGS. 2(a) and 2(b), a plurality of dynamic pressure grooves 23, 24 are formed in a spiral pattern or the like in each of the thrust bearing faces. These dynamic pressure groove regions are formed simultaneously with the injection molding of the flange portion 2b. The thrust bearing face formed on the upper end face 2b1 of the flange portion 2b faces the lower end face 8c of the bearing sleeve 8 across a thrust bearing gap, thus forming the first thrust bearing portion T1. Likewise, the thrust bearing face formed on the lower end face 2b2 of the flange portion 2b faces the inside bottom face 7c1 of the housing bottom portion 7c across a thrust bearing gap, thus forming the second thrust bearing portion T2.

In the above structure, when the shaft member 2 and the bearing sleeve 8 rotate relative to each other, that is, in the present embodiment, when the shaft member 2 rotates, a dynamic pressure is generated in the lubricating oil in the radial bearing gaps 9a and 9b of the radial bearing portions R1 and R2 by the action of the dynamic pressure grooves 8a1 to 8a4, as earlier described, and the shaft portion 2a of the shaft member 2 is supported in a noncontact fashion in such a manner as to be rotatable in the radial direction by the lubrication oil film formed in the respective radial bearing gaps. At the same time, a dynamic pressure is generated in the lubricating oil in the thrust bearing gaps of the thrust bearing portions T1 and T2 by the action of the dynamic pressure grooves 23 and 24, and the flange portion 2b of the shaft member 2 is supported in a noncontact fashion in such a manner as to be rotatable in both thrust directions by the lubrication oil film formed in the respective thrust bearing gaps.

In the present invention, since, in the shaft member 2, only the outer circumferential portion of the shaft portion 2a is formed from the metal member 22, and the other portions of the shaft member 2 are formed from the resin member 21, the weight is reduced compared with the conventional metal shaft. This serves to reduce the impact when the shaft member 2 collides with the bearing sleeve 8 or the housing bottom portion 7c, and thereby to prevent such portions from being scratched or nicked by the collision. Further, since the flange portion 2b is made of resin, it provides good sliding faces against the lower end face 8c of the metal bearing sleeve 8 and the metal housing bottom portion 7c, and the required torque can thus be reduced.

Furthermore, compared with the metal bearing sleeve 8 and the metal housing bottom portion 7c, the flange portion 2b made of resin has a larger coefficient of linear axial expansion; as a result, when the bearing temperature rises due to motor driving, etc., the width of each thrust bearing gap decreases. This can compensate for the decrease in the rigidity of the oil film resulting from decreased oil viscosity, and thus the bearing rigidity in the thrust direction can be retained. Generally, at low temperatures, for example, immediately after power on, since the oil viscosity is high, the required torque increases, but in the present invention, this kind of torque increase can be avoided because the thrust bearing gaps expand due to the difference in the coefficient of linear expansion.

FIG. 6 is a cross sectional view showing an alternative embodiment of the shaft member 2. This embodiment is constructed so that a separate member can be screwed onto the upper end of the shaft member 2; in the illustrated example, a cap 26, as the separate member, for fixedly holding a disk or the like is secured to the shaft member 2 with a screw 27. In the shaft portion 2a, the upper end of the cylindrical metal member 22 extends in the axial direction beyond the upper end of the resin member 21, and a female thread 25 into which the screw 27 is to be screwed is formed on the inner circumference of the extended portion. Below the thread 25 is located the upper end of the resin member 21, and further below it, the resin member 21 and the metal member 22 are held in engagement along the axial direction by means of the tapered face 22b. By forming the thread 25 on the inner circumferential surface of the metal member 22 in this way, the strength and durability of the screw fastening portion can be increased compared with the case if the thread were formed on the resin member 21. In other respects, the construction, fabrication method, etc. are the same as those of the shaft member 2 shown in FIGS. 1 and 2, and a detailed description thereof will not be repeated here.

The shaft member 2 has been described above by taking as an example the case where the outer circumference of the shaft portion 2a is constructed from the metal member 22, but the construction of the shaft member 2 is not restricted to this particular example. For example, while the entire portion of the flange 2b is formed using a resin in the illustrated example, its core portion may be formed using a metal material.

In the illustrated example, the thrust bearing faces with the dynamic pressure grooves 23 and 24 formed therein are formed on both end faces of the flange portion 1b, but alternatively, either one of the thrust bearing faces may be formed on the inside bottom face 7c1 of the housing 7 or on the end face 8c of the bearing sleeve 8 that faces the end face of the flange portion 2b. Further, the bearing gap of the thrust bearing portion T2 that supports the shaft member 2 from below may be formed between the upper end face 7f (see FIG. 4) of the housing 7 and the lower end face of the hub 3 that faces it. Further, a multilobe bearing, a step bearing, a taper bearing or a taper-flat bearing, etc. can be used as the respective radial bearing portion R1 and R2.

1. A dynamic pressure bearing unit comprising: a bearing sleeve; a shaft member having a shaft portion inserted along an inner circumference of said bearing sleeve, and a flange portion extending radially outwardly of said shaft portion; a radial bearing portion for supporting said shaft member in a radial direction in a noncontact fashion by fluid dynamic pressure action occurring in a radial bearing gap; and a thrust bearing portion for supporting said shaft member in a thrust direction in a noncontact fashion by fluid dynamic pressure action occurring in a thrust bearing gap, wherein
an outer circumference of said shaft portion of said shaft member is formed from a cylindrically shaped hollow metal member, while said flange portion and a core of said shaft portion are both formed from a resin member.

2. A dynamic pressure bearing unit according to claim 1, wherein said shaft member is formed by molding a resin in a mold cavity using said metal member as an insert.

3. A dynamic pressure bearing unit according to claim 1, wherein in said shaft member, a plurality of dynamic pressure grooves are formed at least in one end face of said flange portion.

4. A dynamic pressure bearing unit according to claim 3, wherein said dynamic pressure grooves are formed in said end face of said flange portion simultaneously with the molding of said flange portion.

5. A dynamic pressure bearing unit according to claim 1, wherein a thread into which a separate member is to be screwed is formed in an opposite end portion of said shaft member from said flange portion.

6. A dynamic pressure bearing unit according to claim 5, wherein said thread is formed around an inner circumference of an end portion of said metal member.

7. A dynamic pressure bearing unit according to claim 1, further comprising a housing in which said bearing sleeve is accommodated, wherein said flange portion is disposed with one end face thereof facing an end face of said bearing sleeve and with the other end face thereof facing a bottom face of said housing.

8. A dynamic pressure bearing unit according to claim 2, further comprising a housing in which said bearing sleeve is accommodated, wherein said flange portion is disposed with one end face thereof facing an end face of said bearing sleeve and with the other end face thereof facing a bottom face of said housing.

9. A dynamic pressure bearing unit according to claim 3, further comprising a housing in which said bearing sleeve is accommodated, wherein said flange portion is disposed with one end face thereof facing an end face of said bearing sleeve and with the other end face thereof facing a bottom face of said housing.

10. A dynamic pressure bearing unit according to claim 4, further comprising a housing in which said bearing sleeve is accommodated, wherein said flange portion is disposed with one end face thereof facing an end face of said bearing sleeve and with the other end face thereof facing a bottom face of said housing.

11. A dynamic pressure bearing unit according to claim 5, further comprising a housing in which said bearing sleeve is accommodated, wherein said flange portion is disposed with one end face thereof facing an end face of said bearing sleeve and with the other end face thereof facing a bottom face of said housing.

12. A dynamic pressure bearing unit according to claim 6, further comprising a housing in which said bearing sleeve is accommodated, wherein said flange portion is disposed with one end face thereof facing an end face of said bearing sleeve and with the other end face thereof facing a bottom face of said housing.
